(19) United States
(12) Patent Application Publication
(10) Pub. No.: US 2025/0062492 A1
(43) Pub. Date: Feb. 20, 2025

(54) SEPARATOR FOR SECONDARY BATTERY AND LITHIUM SECONDARY BATTERY COMPRISING THE SAME

(71) Applicant: SK ON CO., LTD., Seoul (KR)

(72) Inventors: Jeong Han KIM, Daejeon (KR); Whee Sung KIM, Daejeon (KR); Dae Yong YEON, Daejeon (KR); Yun Kyung JO, Daejeon (KR)

(21) Appl. No.: 18/791,452

(22) Filed: Aug. 1, 2024

(30) Foreign Application Priority Data
Aug. 16, 2023 (KR) 10-2023-0107140

(51) Int. Cl. H01M 50/451; H01M 10/0525; H01M 50/417; H01M 50/434; H01M 50/443; H01M 50/446; H01M 50/489

(52) U.S. Cl. CPC H01M 50/451; H01M 10/0525; H01M 50/417; H01M 50/434; H01M 50/443; H01M 50/446; H01M 50/489

(57) ABSTRACT

A separator for a secondary battery includes a porous substrate and an inorganic coating layer formed on one or both surfaces of the porous substrate and including an inorganic material, wherein an average particle diameter D50 of the inorganic material is 3 to 20% of a thickness of the inorganic coating layer, wherein a TMA fracture temperature of the separator is 150° C. or higher.

### CROSS-REFERENCE TO RELATED APPLICATION(S)

This patent document claims the priority and benefits of Korean Patent Application No. 10-2023-0107140 filed on Aug. 16, 2023, the disclosure of which is incorporated herein by reference in its entirety.

### TECHNICAL FIELD

The present disclosure relates to a separator for secondary batteries and a lithium secondary battery including the same.

### BACKGROUND

Lithium secondary batteries, which have high energy density and are easy to carry, have been mainly used as driving power sources for mobile information terminals, such as mobile phones, laptops, and smartphones. In addition, research has recently been actively conducted to use lithium secondary batteries as a power source for driving or storing power in hybrid or battery-powered vehicles by taking advantage of high energy density characteristics thereof. When used in medium-to-large devices, a large number of secondary batteries are electrically connected to increase capacity and output.

One of the main research tasks in lithium secondary batteries is to improve the stability of secondary batteries. In particular, if thermal runaway occurs due to heat generated from a decomposition reaction of an active material, excessive current may occur due to damage to a separator, a short-circuit between a positive electrode and a negative electrode, an internal short-circuit, which may cause thermal runaway of the entire battery pack.

Therefore, in order to improve the safety of secondary batteries, there is a need to develop a separator having high strength and high thermal resistance.

### SUMMARY

The present disclosure may be implemented in some embodiments to provide a separator having improved voltage resistance by improving a pore state and thermal resistance of the separator.

The present disclosure may be implemented in some embodiments to provide a lithium secondary battery having improved safety due to a low frequency of breakdown and excellent overcharge evaluation.

In some embodiments of the present disclosure, a separator for a secondary battery includes: a porous substrate; and an inorganic coating layer formed on one or both surfaces of the porous substrate and including an inorganic material, wherein an average particle diameter D50 of the inorganic material is 3 to 20% of a thickness of the inorganic coating layer, wherein a TMA fracture temperature of the separator is 150° C. or higher.

A breakdown voltage of the separator may be 1 kV or more.

A breakdown area of the separator may be 15 mm² or less.

A permeability of the separator may be 10 to 200 sec/100 cc.

A thickness of the porous substrate may be 3 to 25 μm.

A thickness of the inorganic coating layer may be 0.5 to 20 μm.

The average particle diameter D50 of the inorganic material may be 0.01 to 3 μm.

A planar density of the inorganic material and a planar density of the inorganic coating layer may satisfy the relationship of Equation 1 below.

95≤(planar density of inorganic material)/(planar density of inorganic coating layer)×100(%)≤99 [Equation 1]

The inorganic material may be at least one selected from the group consisting of aluminum hydroxide (Al(OH)₃), magnesium hydroxide (Mg(OH)₂), oxide (Al₂O₃), aluminum magnesium oxide (MgO), calcium oxide (Ca), barium sulfate (BaSO₄), boehmite, titanium dioxide (TiO₂), silica (SiO₂), and clay.

The inorganic coating layer may further include a binder.

The binder may be at least one selected from the group consisting of polyvinylidene fluoride-hexafluoro propylene (PVdF-HFP), polymethyl methacrylate (PMMA), polyacrylonitrile (PAN), polyvinylpyrrolidone, polyimide, polyethylene oxide (PEO), cellulose acetate, polyvinyl alcohol (PVA), carboxymethyl cellulose (CMC), and polybutylacrylate.

The porous substrate may be at least one selected from the group consisting of polyethylene, polypropylene, polypropylene terephthalate, polyethylene terephthalate, polybutylene terephthalate, polyester, polyacetal, polyamide, polycarbonate, polyimide, polyamideimide, polyetherimide, polyetheretherketone, polyethersulfone, polyphenylene oxide, polyphenylene sulfide, and polyethylene naphthalate, or a copolymer thereof.

In some embodiments of the present disclosure, a lithium secondary battery includes: a positive electrode; a negative electrode; the separator for a secondary battery described above interposed between the positive electrode and the negative electrode; and an electrolyte.

### DETAILED DESCRIPTION

Hereinafter, the present disclosure is described in detail. However, this is merely illustrative and the present disclosure is not limited to the specific embodiments described by way of example.

The term ‘average particle diameter’ used in this description refers to an average particle diameter D50 of inorganic particles and may be defined as a particle diameter based on 50% of particle diameter distribution.

A separator for a secondary battery according to an embodiment may include a porous substrate; and an inorganic coating layer formed on one or both surfaces of the porous substrate and including an inorganic material, wherein an average particle diameter D50 of the inorganic material may be 3 to 20% of a thickness of the inorganic coating layer, and a thermomechanical analysis (TMA) fracture temperature of the separator may be 150° C. or higher.

In an embodiment, the porous substrate on which the inorganic coating layer is uniformly applied may be used without limitation as long as it has high porosity allowing the migration of lithium ions between both electrodes. Such a porous substrate is commonly used in the art, includes a polyolefin porous substrate, and may include porous substrates formed of various other materials.

Specifically, the material may be at least one of polyethylene (high-density polyethylene, low-density polyethylene, linear low-density polyethylene, high molecular weight polyethylene, etc.), polypropylene, polypropylene terephthalate, polyethylene terephthalate, polybutylene terephthalate, polyester, polyacetal, polyamide, polycarbonate, polyimide, polyamideimide, polyetherimide, polyetheretherketone, polyethersulfone, polyphenylene oxide, polyphenylene sulfide, polyethylene naphthalate, etc. or a copolymer thereof, but is not limited thereto.

A thickness of the porous substrate is not particularly limited but may be, for example, 3 μm or more, specifically 6 μm or more, more specifically 9.0 μm or more, 25 μm or less, specifically 20 μm or less, and more specifically 15 μm or less.

In an embodiment, the inorganic coating layer is formed on one or both surfaces of the porous substrate and includes an inorganic material. For a porous substrate having the same thickness, if strength of the porous substrate is high, it may be preferable to form a double-sided coating layer. At this time, since the inorganic coating layer includes inorganic material, in the separator for secondary batteries and the secondary battery including the same, the inorganic particles may provide a function of suppressing a shrinkage rate of the porous substrate to the separator and the separator may be safer by the inorganic coating layer.

The inorganic material may be at least one selected from the group consisting of aluminum hydroxide (Al(OH)₃), magnesium hydroxide (Mg(OH)₂), aluminum oxide (Al₂O₃), magnesium oxide (MgO), calcium oxide (CaO), barium sulfate (BaSO₄), boehmite, titanium dioxide (TiO₂), silica (SiO₂), and clay, but is not limited thereto.

The inorganic material may have an average particle diameter D50 of 0.01 μm or more, specifically 0.2 μm or more, more specifically 0.5 μm or more, 3 μm or less, specifically 2 μm or less, and more specifically 1.0 μm or less. If the average particle diameter is less than 0.01 μm, it may be difficult to be evenly distributed within the separator, and if the average particle diameter exceeds 3 μm, it may have a negative effect on the uniformity of the surface of the separator and thickness uniformity of the separator and ability to suppress the shrinkage of the porous substrate may be lowered, thereby increasing damage due to rupture in a breakdown situation and increasing a breakdown area due to shrinkage.

According to an embodiment, by limiting the average particle diameter of the inorganic material and the thickness ratio of the inorganic coating layer to a predetermined range, the porosity and thermal resistance of the separator may be improved, and thus, the frequency of breakdown may be reduced and the stability may be improved even when the secondary battery is overcharged.

The average particle diameter D50 of the inorganic material may be 3% or more, specifically 6% or more, more specifically 10% or more, 20% or less, specifically 19.5% or less, more specifically, 19% or less, of the thickness of the inorganic coating layer. If the average particle diameter of the inorganic material is less than 3% of the thickness of the inorganic coating layer, it may be difficult to form pores and the specific surface area may increase, which reduces chemical and electrochemical safety, and if the average particle diameter of the inorganic material exceeds 20%, the density of the inorganic material included in the inorganic coating layer may decrease to lower thermal resistance and reduce a binding area between particles, and the ability to suppress shrinkage of the porous substrate may be reduced, causing wrinkles.

The thickness of the inorganic coating layer may be 0.5 μm or more, specifically 2 μm or more, more specifically 4 μm or more, 20 μm or less, specifically 10 μm or less, and more specifically 5.5 μm or less, but is not limited thereto.

A planar density of the inorganic material and a planar density of the inorganic coating layer may satisfy the relationship of Equation 1 below.

$$95 \leq ( planar density of inorganic material \text{)/(} planar density of inorganic coating layer ) \times 100 ( \% ) \leq 99 \qquad [ Equation 1 ]$$

Specifically, the value of (planar density of inorganic material)/(planar density of inorganic coating layer)×100(%) may be 95.5% or more and 98.5% or less, and more specifically, 96% or more and 98% or less. If the value of (planar density of inorganic material)/(planar density of inorganic coating layer)×100(%) is less than 95%, the content of inorganic material in the coating layer may not be sufficient to suppress the shrinkage of the substrate in a high temperature environment, and if the value exceeds 99%, a binder in the coating layer may be insufficient and binding between particles may be insufficient, which may reduce thermal resistance of the battery and cause the coating layer to detach.

In this case, the binder in the coating layer is insufficient, resulting in insufficient binding between particles, which reduces the thermal resistance of the battery and may cause the coating layer to detach.

In addition, the inorganic coating layer may further include a binder. The binder may be used without limitation as long as it is a commonly used polymer binder. The binders that may be used may include any one of polyvinylidene fluoride-co-hexafluoropropylene, polyvinylidene fluorideco-trichloroethylene, polymethylmethacrylate, polyacrylonitrile, polyvinylpyrrolidone, polyvinylacetate, polyethylene-co-vinyl acetate, polyimide, polyethylene oxide, cellulose acetate, cellulose acetate butyrate, cellulose acetate propionate, cyanoethylpullulan, cyanoethylpolyvinylalcohol, cyanoethylcellulose, cyanoethylsucrose, pullulan, carboxyl methyl cellulose and polyvinylalcohol, or a mixture of two or more thereof. Also, water-soluble or oil-soluble binders other than the above binders used in the art may be used but are not limited thereto.

TMA is an experimental method that usually illustrates thermal behavior of a specimen at high temperature, in which a certain weight is applied to a 5 mm×30 mm specimen and the degree of contraction and stretching of the specimen is measured, while raising the temperature at a constant rate. TMA measurement is not only an item that may evaluate high-temperature stability of the separator itself, but also a method that may predict thermal stability in a battery. Therefore, TMA maximum shrinkage temperature and TMA meltdown temperature may be considered to be a reference for predicting the high temperature stability of the separator and further the thermal stability of the battery.

In the case of a porous substrate including an inorganic coating layer manufactured using the conditions presented in an embodiment, a TMA fracture temperature may be 150° C. or higher, specifically 155° C. or higher. Meanwhile, if the TMA fracture temperature is less than 150° C., it may be difficult to prevent a short-circuit between electrodes in a situation in which the temperature of the battery rises due to damage from overcharge, overdischarge, and other external shocks.

In the present disclosure, a breakdown voltage (BDV) is the highest voltage that an insulator may withstand. Breakdown refers to losing insulating performance as an insulator is destroyed when a voltage applied to the insulator exceeds a certain value. The breakdown voltage in the present disclosure may refer to a voltage measured at the moment at which more than 5.0 mA is conducted by disposing a separator between electrodes for secondary batteries and pressing both electrodes at 500 V/s.

The breakdown voltage of the separator may be 1 kV or more, specifically 1.5 kV or more, and specifically, 2 kV or more. The separator may maintain performance and ensure stability by securing insulation between the inside and outside of the secondary battery within the above range.

In the present disclosure, a breakdown area may refer to the size of a hole formed in the separator due to conduction when the electrodes for secondary batteries are removed after the breakdown voltage is measured.

The breakdown area of the separator may be 15 mm² or less, specifically 14 mm² or less, and more specifically 12 mm² or less. The separator may maintain performance and ensure stability by securing insulation between the inside and outside of the secondary battery within the above range.

The separator according to an embodiment may be applied to a secondary battery. The secondary battery may include a positive electrode; a negative electrode; and the separator described above.

The positive electrode may include a positive electrode current collector and a positive electrode mixture layer disposed on at least one surface of the positive electrode current collector.

The positive electrode current collector may include stainless steel, nickel, aluminum, titanium, or alloys thereof. The positive electrode current collector may include aluminum or stainless steel surface treated with carbon, nickel, titanium, or silver. A thickness of the positive electrode current collector may be, for example, 10 to 50 μm but is not limited thereto.

The positive electrode mixture layer may include a positive electrode active material. The positive electrode active material may include a compound capable of reversibly intercalating and deintercalating lithium ions.

According to embodiments, the positive electrode active material may include lithium-nickel metal oxide. The lithium-nickel metal oxide may further include at least one of cobalt (Co), manganese (Mn), and aluminum (Al).

In some embodiments, the positive electrode active material or the lithium-nickel metal oxide may include a layered structure or a crystal structure represented by Chemical Formula 1 below.

LiₓNiₐM_{b}O_{2+z} [Chemical Formula 1]

In Chemical Formula 1, 0.9≤x≤1.2, 0.6≤a≤0.99, 0.01≤b≤0.4, and −0.5≤z≤0.1. As mentioned above, M may include Co, Mn, and/or Al.

The chemical structure represented by Chemical Formula 1 represents a bonding relationship included in the layered structure or crystal structure of the positive electrode active material and does not exclude other additional elements. For example, M includes Co and/or Mn, and Co and/or Mn may serve as main active elements of the positive electrode active material along with Ni. Chemical Formula 1 is provided to express the bonding relationship of the main active elements and should be understood as encompassing the introduction and substitution of additional elements.

In an embodiment, in addition to the main active elements, auxiliary elements may be further included to improve the chemical stability of the positive electrode active material or the layered structure/crystal structure. The auxiliary elements may be incorporated into the layered structure/crystal structure to form a bond, and in this case, it should be understood that they are included within the range of the chemical structure represented by Chemical Formula 1.

The auxiliary elements may include at least one of, for example, Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr. For example, the auxiliary elements, such as Al, may act as an auxiliary active element contributing to the capacity/output activity of the positive electrode active material together with Co or Mn.

For example, the positive electrode active material or the lithium-nickel metal oxide may include a layered structure or a crystal structure represented by Chemical Formula 1-1 below.

LiₓNiₐM1_{b1}M2_{b2}O_{2+z} [Chemical Formula 1-1]

In Chemical Formula 1-1, M1 may include Co, Mn, and/or Al. M2 may include the auxiliary elements described above. In Chemical Formula 1-1, 0.9≤x≤1.2, 0.6≤a≤0.99, 0.01≤b1+b2≤0.4, and −0.5≤z≤0.1.

The positive electrode active material may further include a coating element or a doping element. For example, elements substantially the same as or similar to the aforementioned auxiliary elements may be used as coating elements or doping elements. For example, any of the aforementioned elements alone or in combination of two or more thereof may be used as a coating element or a doping element.

The coating element or doping element may exist on the surface of the lithium-nickel metal oxide particle, or may penetrate through the surface of the lithium-nickel metal composite oxide particle and be included in the bonding structure represented by Chemical Formula 1 or Chemical Formula 1-1.

The positive electrode active material may include nickel-cobalt-manganese (NCM)-based lithium oxide. In this case, NCM-based lithium oxide with increased nickel content may be used.

Ni may be provided as a transition metal related to the output and capacity of lithium secondary batteries. Therefore, by adopting a high-Ni composition as the positive electrode active material as described above, a high-capacity positive electrode and a high-capacity lithium secondary battery may be provided.

However, as the Ni content increases, long-term storage stability and lifespan stability of the positive electrode or the secondary battery may relatively decrease, and side reactions with an electrolyte may also increase. However, according to embodiments, electrical conductivity may be maintained by including Co, while lifespan stability and capacity maintenance characteristics may be improved through Mn.

The content of Ni (for example, the mole fraction of nickel in the total number of moles of nickel, cobalt, and manganese) in the NCM-based lithium oxide may be 0.6 or more, 0.7 or more, or 0.8 or more. In some embodiments, the Ni content may be 0.8 to 0.95, 0.82 to 0.95, 0.83 to 0.95, 0.84 to 0.95, 0.85 to 0.95, or 0.88 to 0.95.

In some embodiments, the positive electrode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the positive electrode active material may include, for example, an Mn-rich active material having a chemical structure or crystal structure represented by Chemical Formula 2, a Li rich-based layered oxide (LLO)/over lithiated oxide (OLO)-based active material, and a Co-less-based active material.

p[Li₂MnO₃]·(1−p)[Li_{q}JO₂] [Chemical Formula 2]

In Chemical Formula 2, 0<p<1, 0.9≤q≤1.2, and J may include at least one element among Mn, Ni, Co, Fe, Cr, V, Cu, Zn, Ti, Al, Mg, and B.

The negative electrode may include a negative electrode current collector and a negative electrode mixture layer disposed on at least one surface of the negative electrode current collector.

Non-limiting examples of the negative electrode current collector may include copper foil, nickel foil, stainless steel foil, titanium foil, nickel foam, copper foam, and a polymer substrate coated with a conductive metal. A thickness of the negative electrode current collector may be, for example, 10 to 50 μm but is not limited thereto.

The negative electrode mixture layer may include a negative electrode active material. A material capable of adsorbing and desorbing lithium ions may be used as the negative electrode active material. For example, as the negative electrode active material, carbon-based materials, such as crystalline carbon, amorphous carbon, carbon composite, and carbon fiber; a lithium metal; a lithium alloy; a silicon (Si)-containing material or a tin (Sn)-containing material may be used.

Examples of the amorphous carbon may include hard carbon, soft carbon, coke, mesocarbon microbeads (MCMB), and mesophase pitch-based carbon fiber (MPCF).

Examples of the crystalline carbon may include graphite-based carbon, such as natural graphite, artificial graphite, graphitized coke, graphitized MCMB, and graphitized MPCF.

The lithium metal may include pure lithium metal or lithium metal with a protective layer formed thereon to inhibit dendrite growth. In an embodiment, a lithium metal-containing layer deposited or coated on a negative electrode current collector may be used as a negative electrode active material layer. In an embodiment, a lithium thin film layer may be used as a negative electrode active material layer.

Elements included in the lithium alloy may include aluminum, zinc, bismuth, cadmium, antimony, silicon, lead, tin, gallium, and indium.

The silicon-containing material may provide increased capacitance properties. The silicon-containing material may include Si, SiOx (0<x<2), metal-doped SiOx (0<x<2), silicon-carbon composite, etc. The metal may include lithium and/or magnesium, and the metal-doped Siox (0<x<2) may include metal silicate.

According to embodiments, an electrode assembly may be formed by repeatedly arranging a positive electrode, a negative electrode, and a separator. In some embodiments, the electrode assembly may be of a winding type, a stacking type, a zigzag folding type, or a stack-folding type.

The electrode assembly may be accommodated with an electrolyte in a case to define a lithium secondary battery. According to embodiments, a non-aqueous electrolyte solution may be used as the electrolyte.

The non-aqueous electrolyte solution may include a lithium salt as an electrolyte and an organic solvent. The lithium salt may be expressed, for example, as Li⁺X⁻, and the anions (X−) of the lithium salt may include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻.

The organic solvent may include an organic compound having sufficient solubility for lithium salt and additives and being not reactive in the battery. The organic solvent may include, for example, at least one of a carbonate-based solvent, an ester-based solvent, an ether-based solvent, a ketone-based solvent, an alcohol-based solvent, and an aprotic solvent. As the organic solvent, for example, propylene carbonate (PC), ethylene carbonate (EC), butylene carbonate, diethyl carbonate (DEC), dimethyl carbonate (DMC), and ethylmethyl carbonate (EMC), methylpropyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfuroxide, acetonitrile, dimethoxyethane, diethoxyethane, sulfolane, gamma-butyrolactone, and propylene sulfite may be used. These may be used alone or in combination of two or more thereof.

### Example

Hereinafter, examples of the present disclosure are further described with reference to specific experimental examples. The examples included in the experimental examples and comparative examples are merely illustrative of the present disclosure and do not limit the scope of the appended patent claims, it is obvious to those skilled in the art that various changes and modifications may be made to the examples within the scope and technical spirit of the present disclosure, and it is natural that such variations and modifications fall within the scope of the appended patent claims.

### 1. Example 1

### (1) Manufacturing of Separator

One surface of a polyethylene porous substrate having a thickness of 9 or 11 μm is coated with a slurry obtained by mixing boehmite (average particle diameter 0.5, 0.7, 1.0, 1.2, 1.4 μm) and a polyimide binder according to Table 1 below in an aqueous solvent to form an inorganic coating layer.

At this time, the ratio of boehmite to the inorganic coating layer was prepared based on the inorganic material planar density/inorganic coating layer planar density according to Table 1 below, and the aqueous solvent was mixed in a weight equal to the total weight of boehmite and polyimide binder.

The physical properties of the prepared separator were measured and shown in Table 1 below.

### (2) Manufacturing of Positive Electrode

94 wt % of LiCoO₂ as a positive electrode active material, 2.5 wt % of polyvinylidene fluoride as an adhesive, and 3.5 wt % of Super-P (Imerys) as a conductive material were added to N-methyl-2-pyrrolidone (NMP) as an organic solvent and stirred to prepare a uniform positive electrode slurry. The slurry was coated on a 30 μm-thick aluminum foil, dried at a temperature of 120° C., and then compressed to produce a 150 μm-thick positive electrode plate.

### (3) Manufacturing of Negative Electrode

95 wt % of artificial graphite as a negative electrode active material, 3 wt % of acrylic latex (BM900B, 20 wt % of solid content) with a T_{g} at −52° C. as an adhesive, and 2 wt % of carboxymethyl cellulose (CMC) as a thickener were added to water as a solvent and stirred to prepare a uniform negative electrode slurry. The slurry was coated on a 20 μm-thick copper foil, dried at a temperature of 120° C., and then compressed to prepare a 150 μm-thick negative electrode plate.

### (4) Manufacturing of Lithium Secondary Battery

A pouch-type battery was assembled in a stacking manner using the positive electrode, the negative electrode, and the separator prepared as described above, and an electrolyte solution including a solvent of ethylene carbonate (EC)/ethyl methyl carbonate (EMC)/dimethyl carbonate (DMC)=3:5:2 (volume ratio) in which 1 M of lithium hexafluorophosphate (LiPF₆) was dissolved was injected into each battery to manufacture a lithium secondary battery.

### 2. Examples 2 to 3 and Comparative Examples 1 to 6

Separators and lithium secondary batteries were manufactured in the same manner as in Example 1, except that the physical properties according to Table 1 below were changed.

TABLE 1

| | | | | Compar- | Compar- | Compar- | Compar- | Compar- | Compar- |
|---|---|---|---|---|---|---|---|---|---|
| | Exam- | Exam- | Exam- | ative | ative | ative | ative | ative | ative |
| | ple | ple | ple | Exam- | Exam- | Exam- | Exam- | Exam- | Exam- |
| | 1 | 2 | 3 | ple 1 | ple 2 | ple 3 | ple 4 | ple 5 | ple 6 |
| Thickness of | 11.0 | 9.0 | 9.0 | 9.0 | 9.0 | 11.0 | 16 | 11 | 9 |
| porous | | | | | | | | | |
| substrate | | | | | | | | | |
| (μm) | | | | | | | | | |
| Thickness of | 4.0 | 5.5 | 4.0 | 5.0 | 5.5 | 4.0 | 5.5 | 5.5 | 3.0 |
| inorganic coating layer | | | | | | | | | |
| (μm) | | | | | | | | | |
| Thickness of | 15.0 | 14.5 | 13.0 | 14.0 | 14.5 | 15.0 | 21.5 | 16.5 | 12 |
| separator | | | | | | | | | |
| (μm) | | | | | | | | | |
| Average | 0.5 | 1.0 | 0.7 | 1.4 | 1.2 | 0.7 | 3.2 | 1.0 | 0.5 |
| particle | | | | | | | | | |
| diameter of | | | | | | | | | |
| inorganic | | | | | | | | | |
| material D50 | | | | | | | | | |
| (μm) | | | | | | | | | |
| Average | 12.5 | 18.2 | 17.5 | 28.0 | 21.8 | 17.5 | 58.2 | 18.2 | 16.7 |
| particle | | | | | | | | | |
| diameter of inorganic | | | | | | | | | |
| material/thickness | | | | | | | | | |
| of inorganic | | | | | | | | | |
| coating layer × | | | | | | | | | |
| 100 (%) | | | | | | | | | |
| Planar | 7.81 | 10.27 | 7.57 | 9.01 | 9.28 | 6.19 | 13.03 | 9.98 | 7.59 |
| density of inorganic | | | | | | | | | |
| material | | | | | | | | | |
| (g/m²) | | | | | | | | | |
| Planar | 8.06 | 10.51 | 7.74 | 9.69 | 9.87 | 7.28 | 16.11 | 10.21 | 8.19 |
| density of | | | | | | | | | |
| inorganic | | | | | | | | | |
| coating layer | | | | | | | | | |
| (g/m²) | | | | | | | | | |
| Planar | 97 | 98 | 98 | 93 | 94 | 85 | 81 | 98 | 93 |
| density of inorganic | | | | | | | | | |
| material/planar | | | | | | | | | |
| density of inorganic | | | | | | | | | |
| coating layer × | | | | | | | | | |
| 100 (%) | | | | | | | | | |
| Permeability | 180 | 168 | 152 | 148 | 113 | 165 | 148 | 191 | 148 |
| (sec/100 cc) | | | | | | | | | |

### Evaluation Example

According to a physical property evaluation method below, the physical properties of the separators and lithium secondary batteries manufactured in Examples 1 to 3 and Comparative Examples 1 to 6 were evaluated, and the results are shown in Table 2.

### (1) Heat Shrinkage Rate

The sizes of the separators of Examples 1 to 3 and Comparative Examples 1 to 6 were measured before and after being stored in a chamber at 130° C. for one hour, and changes thereof were checked.

### (2) TMA Fracture Temperature

Using METTLER TOLEDO'S TMA (Thermo-mechanical Analysis) equipment, temperatures at which the separators of Examples 1 to 3 and Comparative Examples 1 to 6 were broken when a force of 0.03 N/mm was applied, while increasing temperature at 5° C./min. in a nitrogen (N₂) environment, were measured.

### (3) Breakdown Voltage (BDV)

Both electrodes of the lithium secondary batteries of Examples 1 to 3 and Comparative Examples 1 to 6 were pressed at 500 V/s and voltages at the moment at which 5.0 mA or more was conducted were measured.

In addition, the thicknesses of the separators were measured to measure breakdown voltages per unit thickness of the separators.

### (4) Breakdown Area

After measuring the breakdown voltages, the sizes of the holes formed by conduction were measured in the separators from which the electrodes were removed.

### (5) Evaluation of Insulation Resistance

A DC voltage of 200V was applied to the electrode assemblies including the separators, positive electrodes, and negative electrodes of Examples 1 to 3 and Comparative Examples 1 to 6 and without an electrolyte solution, and a case in which a resistance value exceeding 0.5 MΩ was determined as pass and a case in which a resistance value of 0.5 MΩ or less was determined as fail.

### (6) Evaluation of Overcharge

After charging the lithium secondary batteries of Examples 1 to 3 and Comparative Examples 1 to 6 to 5.5V at 1 C, 5.5V was maintained and a case in which no ignition or smoke occurred for 2 hours was determined as pass and a case in which ignition or smoke occurred was determined as fail.

### (7) Evaluation of Heat Exposure

The lithium secondary batteries of Examples 1 to 3 and Comparative Examples 1 to 6 were exposed to 150° C. for 1 hour, and a case in which no ignition or smoke occurred was determined as pass and a case in which ignition or smoke occurred was determined as fail.

TABLE 2

| | | | | Compar- | Compar- | Compar- | Compar- | Compar- | Compar- |
|---|---|---|---|---|---|---|---|---|---|
| | Exam- | Exam- | Exam- | ative | ative | ative | ative | ative | ative |
| | ple | ple | ple | Exam- | Exam- | Exam- | Exam- | Exam- | Exam- |
| | 1 | 2 | 3 | ple 1 | ple 2 | ple 3 | ple 4 | ple 5 | ple 6 |
| Heat | 1 | 4 | 5 | 7 | 8 | 21 | 19 | 2 | 6 |
| shrinkage | | | | | | | | | |
| rate (%) | | | | | | | | | |
| TMA fracture | 155 | 151 | 155 | 146 | 148 | 139 | 151 | 141 | 152 |
| temperature | | | | | | | | | |
| (° C.) | | | | | | | | | |
| BVD (kV) | 2.45 | 2.01 | 1.95 | 1.86 | 1.76 | 2.21 | 2.01 | 2.18 | 1.61 |
| BVD per unit | 0.163 | 0.139 | 0.150 | 0.124 | 0.114 | 0.147 | 0.093 | 0.132 | 0.134 |
| thickness (kV/μm) | | | | | | | | | |
| Breakdown | 7 | 12 | 11 | 18 | 21 | 17 | 19 | 25 | 23 |
| area | | | | | | | | | |
| (mm²) | | | | | | | | | |
| Evaluation of | Pass | Pass | Pass | Fail | Fail | Fail | Fail | Pass | Fail |
| insulation | | | | | | | | | |
| resistance | | | | | | | | | |
| during | | | | | | | | | |
| battery | | | | | | | | | |
| assembly | | | | | | | | | |
| Evaluation of | Pass | Pass | Pass | Fail | Fail | Fail | Pass | Fail | Fail |
| overcharge | | | | | | | | | |
| Evaluation of | Pass | Pass | Pass | Fail | Fail | Fail | Fail | Fail | Fail |
| heat exposure | | | | | | | | | |

Referring to Table 2 above, it can be seen that the separators of Examples 1 to 3 showed excellent evaluation of insulation resistance during battery assembly and excellent results in evaluation of overcharge and heat exposure of the completed secondary batteries. Meanwhile, in the separators of Comparative Examples 1 and 2 in which the size of the average particle diameter D50 of an inorganic material was appropriate but the size of the average particle diameter D50 of an inorganic material is large compared to the thickness of the inorganic coating layer, the ability of the inorganic coating layer to suppress shrinkage of the porous substrate was lowered, so the breakdown voltage was low, and in the case of fracture in the breakdown situation, a breakdown area increased due to damage and shrinkage due to the fracture, and as a result, the evaluation of insulation resistance during battery assembly is inferior, and the evaluation of overcharge and evaluation of heat exposure of the completed secondary battery are also inferior.

The separator of Comparative Example 3 does not have a large average particle size D50 compared to the thickness of the inorganic coating layer, but the TMA fracture temperature is low and the breakdown area is large due to the low inorganic content in the inorganic coating layer, and as a result, the evaluation of insulation resistance during battery assembly is inferior, and the evaluation of overcharge and evaluation of heat exposure of the completed secondary battery are also inferior.

It can be seen that, the separator of Comparative Example 4 had a large average inorganic particle diameter D50, so the inorganic material average particle diameter/inorganic coating layer thickness with the porous substrate was not appropriate, and the fracture area at the time of breakdown was large, so the evaluation of insulation resistance during battery assembly was not satisfied.

In Comparative Example 5, it can be seen that, the inorganic material average particle diameter and the inorganic material average particle diameter/inorganic coating layer e appropriate, but the TMA fracture temperature was low, so the evaluation in overcharge and heat exposure was poor.

The separator of Comparative Example 6 satisfies the inorganic material average particle diameter/coating layer thickness and also satisfies the TMA fracture temperature, but the inorganic material is not sufficient in the coating layer, so the inorganic material planar density/inorganic coating layer planar density is low, resulting in inferior breakdown area. Accordingly, it can be seen that the evaluation of insulation resistance during battery assembly is inferior.

According to an aspect of the present disclosure, the withstand voltage of the separator may be improved.

According to another aspect of the present disclosure, the frequency of breakdown of the lithium secondary battery is low and the evaluation of overcharge is excellent, thereby improving safety.

Only specific examples of implementations of certain embodiments are described. Variations, improvements and enhancements of the disclosed embodiments and other embodiments may be made based on the disclosure of this patent document.

What is claimed is:

1. A separator for a secondary battery, the separator comprising:
a porous substrate; and
an inorganic coating layer formed on one or both surfaces of the porous substrate and including an inorganic material,
wherein e particle diameter D50 of the inorganic material is 3 to 20% of a thickness of the inorganic coating layer,
wherein a TMA fracture temperature of the separator is 150° C. or higher.

2. The separator of claim 1, wherein a breakdown voltage of the separator is 1 kV or more.

3. The separator of claim 1, wherein a breakdown area of the separator is 15 mm² or less.

4. The separator of claim 1, wherein a permeability of the separator is 10 to 200 sec/100 cc.

5. The separator of claim 1, wherein a thickness of the porous substrate is 3 to 25 μm.

6. The separator of claim 1, wherein a thickness of the inorganic coating layer is 0.5 to 20 μm.

7. The separator of claim 1, wherein the average particle diameter D50 of the inorganic material is 0.01 to 3 μm.

8. The separator of claim 1, wherein a planar density of the inorganic material and a planar density of the inorganic coating layer satisfy the relationship of Equation 1 below,
95≤(planar density of inorganic material)/(planar density of inorganic coating layer)×100(%)≤99. [Equation 1]

9. The separator of claim 1, wherein the inorganic material is at least one selected from the group consisting of aluminum hydroxide (Al(OH)₃), magnesium hydroxide (Mg(OH)₂), aluminum oxide (Al₂O₃), magnesium oxide (MgO), calcium oxide (Cao), barium sulfate (BaSO₄), boehmite, titanium dioxide (TiO₂), silica (SiO₂), and clay.

10. The separator of claim 1, wherein the inorganic coating layer further includes a binder.

11. The separator of claim 10, wherein the binder is at least one selected from the group consisting of polyvinylidene fluoride-hexafluoro propylene (PVdF-HFP), polymethyl methacrylate (PMMA), polyacrylonitrile (PAN), polyvinylpyrrolidone, polyimide, polyethylene oxide (PEO), cellulose acetate, polyvinyl alcohol (PVA), carboxymethyl cellulose (CMC), and polybutylacrylate.

12. The separator of claim 1, wherein the porous substrate is at least one selected from the group consisting of polyethylene, polypropylene, polypropylene terephthalate, polyethylene terephthalate, polybutylene terephthalate, polyester, polyacetal, polyamide, polycarbonate, polyimide, polyamideimide, polyetherimide, polyetheretherketone, polyethersulfone, polyphenylene oxide, polyphenylene sulfide, and polyethylene naphthalate, or a copolymer thereof.

13. A lithium secondary battery comprising:
a positive electrode;
a negative electrode;
the separator for a secondary battery of claim 1 interposed between the positive electrode and the negative electrode; and
an electrolyte.
